(19) United States
(12) Patent Application Publication
(10) Pub. No.: US 2005/0155964 A1
(43) Pub. Date: Jul. 21, 2005

(54) Woodburning device

(75) Inventor: Mathias d'Estais, Cairon (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Heller (S.A.), a corporation of France, Trun (FR)

(21) Appl. No.: 11/009,647

(22) Filed: Dec. 10, 2004

Related U.S. Application Data
(63) Continuation of application No. PCT/FR03/01911, filed on Jun. 20, 2003.

(30) Foreign Application Priority Data
Jun. 20, 2002 (FR) 02/07666

(51) Int. Cl. F24C 1/14; H05B 1/00

(52) U.S. Cl. 219/229

(57) ABSTRACT

A woodburning device including a heated tip, an elongated case delimited by a guard device having a substantially circular protrusion and prolonged by a protective cage which allows emergence of a end of the heated tip only when the device is in an operational mode.

### RELATED APPLICATION

This is a continuation of International Application No. PCT/FR2003/001911, with an international filing date of Jun. 20, 2003 (WO 2004/000576, published Dec. 31, 2003), which is based on French Patent Application No. 02/07666, filed Jun. 20, 2002.

### FIELD OF THE INVENTION

This invention pertains to a woodburning device. It applies especially, but not exclusively to, woodburning activities on wood intended for children.

### BACKGROUND

Woodburning is considered to be an early-learning activity or an activity for the intellectual and artistic development of the child. The concept of woodburning consists of heating a metal tip and bringing the tip into contact with a material in a manner such that the material burns or carbonizes under the action of the heated tip. Children often engage in woodburning because this practical exercise is considered to be particularly formative for children.

When children engage in woodburning, it is necessary to provide a maximum safety system to prevent the children's bodies or any other flammable material from coming into contact with the heated tip. In fact, the tips of woodburning devices are on average brought to a temperature close to 400° C., and certain attachment parts commonly reach 150° C.

There are several types of woodburning devices on the market: inertia woodburning tools and filament woodburning tools.

Inertia woodburning tools operate on the same principle as a soldering iron, i.e., by electrically heating the tip of the woodburning tool. In such a case, the tip of the woodburning device has a temperature close to 400° C.

Filament woodburning tools generally use a tungsten filament. The material made of tungsten is heated by the passage of an electric current, essentially in the same manner as a conventional electric light bulb; the tip is heated under the action of this electric current. In such a case, the tip of the woodburning device has a temperature often close to 450° C.

In fact, any material having a high resistance to electrical current as well as a relatively high melting point can be used to constitute the material of the tip of a woodburning tool.

For the purpose of illustrating a conventional woodburning device, U.S. Pat. No. 2,101,913 describes a heated tip that can be retracted into the interior of the woodburning device; the withdrawal of the heated tip allows the woodburning tool to heat the tip. Thus, in that type of set-up there is no protective system to protect the user from being burned upon contact with the heated tip.

Thus, known woodburning devices have a certain number of drawbacks. In fact, these devices which do not provide suitable protection system represent a potentially very great danger in particular for children. Furthermore, there does not presently exist a system that indicates the operating state of the woodburning device.

### SUMMARY OF THE INVENTION

This invention relates to a woodburning device including a heated tip, an elongated case delimited by a guard device having a substantially circular protrusion and prolonged by a protective cage which allows emergence of an end of the heated tip only when the device is in an operational mode.

### BRIEF DESCRIPTION OF THE DRAWINGS

Better understanding of the invention will be obtained from the description below, presented for purely explanatory purposes, of examples of the woodburning device according to aspects of the invention with reference to the attached figures:

FIG. 1 is a schematic view of a woodburning device according to aspects of the invention;

FIG. 2 is an exploded view comprising all of the elements composing one aspect of the invention;

FIG. 3 is a sectional view of the woodburning device of FIG. 2, but assembled and mounted; and

FIG. 4 is a side view of the device shown in FIG. 3.

### DETAILED DESCRIPTION

It will be appreciated that the following description is intended to refer to specific embodiments of the invention selected for illustration in the drawings and is not intended to define or limit the invention, other than in the appended claims.

This invention provides a woodburning device comprising a case that is essentially elongated such that it can be grasped by a user, comprising at one end a wire connection to provide electrical power and at the other end a heated tip, a protective cage surrounding the tip such that only its end protrudes beyond the cage and a pushbutton acting to advance the heated tip beyond the protective cage or vice versa to withdraw the tip into the interior of the protective cage.

The protective cage advantageously has the shape of a truncated cone. The protective cage is preferably made of plastic, e.g., a thermoplastic, a thermoset plastic or the like.

According to one aspect, the woodburning device furthermore comprises a fan positioned in the direction of the tip to blow out air to the exterior of the device; the blown or expelled air passing between the tip and interior wall of the protective cage. Thus, the case can also comprise at least one motor, e.g., an electric motor powered with electricity via the electrical connection, connected to the fan.

According to another aspect, the external atmospheric air stemming from the open end in which is positioned the heated tip is aspirated by the rotation of the fan. The cooling of the heated tip and the hot parts is then comparable to the aspect described above. Fumes can then be evacuated via an exhaust line located opposite the heated tip or moved further away by the intermediary of a flexible tube.

According to another aspect, the motor and the fan are moved to the exterior of the case to lighten the woodburning device, the ventilated air then circulating between the fan and the device via a tube.

The woodburning device preferably comprises a pushbutton controlling the on-off function of the device, i.e., the heating or termination of heating of the tip. In one aspect, when the pushbutton is put in the “off” position, the fan is made to turn more rapidly so that the tip will cool off quickly.

The woodburning device advantageously also comprises a warning or operating light indicating the operating state of the device. Thus, the light may, e.g., be illuminated with a green light when the pushbutton is in the “off” position and with a red light when the pushbutton is in the “on” position.

The pushbutton preferably comprises a control device acting to cause the tip to advance beyond the protective cage or vice versa to be withdrawn inside the cage.

By means of these particular features, the invention enables, due to its internal ventilation system, maintenance of a temperature which does not exceed about 35° C. on any of the accessible zones of the woodburning device with the exception of the functional tip. The versions of the prior art have a temperature of the grasping body greater than 50° C.

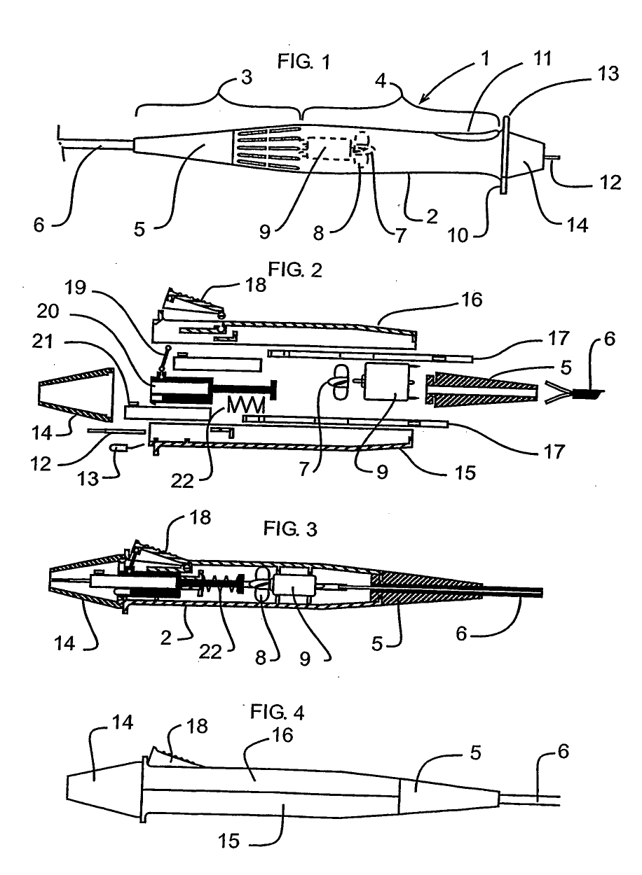

Turning now to the Drawings, the woodburning device 1 shown in FIG. 1 comprises an elongated or oblong case advantageously having a suitable or ergonomic form for being held in a user's hand (not shown in the different figures). Case 2 has two parts 3 and 4.

The first part 3 has a wire guide 5 essentially in the form of a truncated cone that guides the electric wires 6 sheathed in insulating plastic to the inside of the case 2. The wire guide 5 makes it possible to keep the electric wire connection 6 at a distance from the tip 12 and lightens handling by facilitating displacement of the wire 6.

It should be noted that the heating device for the heated tip 12 operates in a conventional manner.

Thus, the woodburning device 1 is supplied with electric power via at least one wire connection 6. As required, device 1 is connected to an electric supply. Nevertheless, it is possible to provide for the use of another means of generation or storage of electric power to provide an independent, self-contained woodburning device, e.g., a battery or battery system.

In the example selected to illustrate aspects of the invention, a fan 7 of suitable form and size is housed inside case 2. This fan 7 has a rotor 8, the blades of which are oriented in the direction opposite to the wire guide 5, i.e., when the fan 7 is operating, it expels or blows out air in the direction of the heated tip located opposite the first part 3. The fan 7 operates with an electric motor 9 supplied with electric power via the wire connection 6.

The ventilator 7 makes it possible to disperse the fumes that can be harmful to the eyes and to limit the heating of the peripheral zones of the heated tip such as the case 2 or the guard device 10 provided to make secure the holding of the woodburning device 1.

The second part 4 of the case 2 has a generally cylindrical appearance. This second part 4 is intended to receive the user's hand. Its form is therefore designed to match the contours of a hand grasping the second part 4 constituting the holding part of the woodburning device 1.

The second part 4 of the case 2 also comprises a pushbutton 11 for turning the heated tip on and off. Thus, in this device, the pushbutton 11 has the function of providing power to the heated tip. Since this action is commanded by a voluntary act of the user, the tip 12 will not be heated unless the user has the intention of engaging in woodburning. This pushbutton system 11 makes it possible to limit heating to real time use.

The pushbutton 11 moreover secures operation of the woodburning device 1 for the user as well as for people around the user by preventing the risks of untimely burning.

The free end of the second part 4 is delimited by a guard device 10 comprising a circular protrusion which prevents the user's hand from sliding toward the hot zone, i.e., the heated tip 12. Moreover, as a result of guard device 10, as well as the ergonomic design of the case 2 of the device, the user can grasp device 1 close to the heated tip 12 to obtain good precision in the work being executed.

In FIG. 1, the guard device 10 comprises a warning light 13 or operating light which is illuminated, e.g., with a green light when the tip 12 is cool or when the woodburning device 1 is not operating and with a red light when the tip 12 is still hot or the device is operating. By means of this lighting arrangement, the people around the user are aware of the fact that they should or should not approach or handle the woodburning device 1 with caution.

Following the guard device 10 is a protective cage 14. The protective cage 14 is in the form of a truncated cone and is of plastic, e.g., a conventional thermoplastic obtained by molding. This protective cage 14 protects the user or those nearby from contact with the hot zone by only allowing protrusion of the end of the heated woodburning tip 12. Moreover, by limiting access to the woodburning tip 12, this device reduces the risks of fire.

As shown in FIG. 2, the case 2 has two complementary shells 15 and 16, one being the bottom shell 15 and the other being the top shell 16. Close to the interior walls of these two shells 15, 16 are found respectively at least one contact stud 17 for the passage and transmission of electric power. The warning light 13 is placed close to the protective cage 14. The woodburning device 1 is equipped with a heated tip 12 housed inside the protective cage 14. The end of the heated tip 12 protrudes beyond the cage 14.

The woodburning device 1 illustrated in FIGS. 2-4 comprises a mechanical pushbutton mechanism comprising a command button 18 or pushbutton, a lever 19, a trolley 20, connection supports 21 in which the interior end of the heated tip 12 is held as well as a spring 22. When the user pushes on the command button 18, button 18 triggers the advance of the connection supports 21 such that the end of the heated tip 12 emerges from the protective cage 14. In the same manner, when the user again pushes the command button 18, the connection supports 21 move into the interior of the case such that the end of the heated tip 12 returns to the interior of the protective cage 14, without allowing any part of the tip 12 protruding beyond the cage 14.

It is also possible to envisage an arrangement in which the user must hold the command button 18 in the pushed-in position such that if the user withdraws or releases the finger or hand maintaining the pushbutton mechanism, it will again withdraw the heated tip 12 into the interior of the protective cage. Upon withdrawal of the heated tip 12 into the interior of the protective cage 14, the fan 7 begins to aspirate or expel more rapidly the surrounding air to accelerate the cooling rate of the heated tip 12. In this manner, the user is able to concentrate more completely on the work at hand because the user does not have to concentrate or be vigilant to ensure the user's own safety.

The preceding description presented operations characteristic of a filament woodburning device. The principles described can be transposed to an inertia woodburning device with retention of the presence of the protective cage, fan and pushbutton triggering the withdrawal of the heated tip.

Also, the invention was described above as an example. It is understood that one skilled in the art can implement different aspects of the woodburning device 1 according to the invention, in particular with regard to the form of the device as well as the arrangement of the different elements composing the device, without departing from the spirit of the invention as defined in the appended claims.

1. A woodburning device comprising a heated tip, an elongated case delimited by a guard device having a substantially circular protrusion and prolonged by a protective cage which allows emergence of a end of the heated tip only when the device is in an operational mode.

2. The woodburning device according to claim 1, wherein the case comprises two complementary shells.

3. The woodburning device according to claim 1, wherein the case has a wire guide substantially in the form of a truncated cone intended to guide electric wires sheathed in insulating plastic into an interior portion of the case.

4. The woodburning device according to claim 1, wherein the case comprises a pushbutton for turning the heated tip “off” and “on.”

5. The woodburning device according to claim 1, further comprising a warning light.

6. The woodburning device according to claim 5, wherein the warning light is illuminated with a green light when the tip is cool or when the woodburning device is not operating and with a red light when the tip is still hot or when the device is operating.

7. The woodburning device according to claim 1, further comprising a fan.

8. The woodburning device according to claim 7, wherein the fan is positioned relative to the heated tip in a manner to blow air exteriorly of the device.

9. The device according to claim 7, wherein the fan is located in the case, wherein the case forms a means for a user to hold the device and has at one end the heated tip.

10. The device according to claim 7, wherein the fan is located exteriorly of the case, wherein the case forms a means for a user to hold the device and has at one end the heated tip, and ventilated air circulates between the fan and the device via a tube.

11. The woodburning device according to claim 1, wherein the protective cage is made of a thermoplastic or a thermoset plastic.

12. The woodburning device according to claim 4, wherein the pushbutton, when placed in a “stop” position, commands the fan to turn more rapidly such that the tip cools down more quickly.

13. The woodburning device according to claim 1, further comprising a command button acting to cause the tip to advance beyond the protective cage or vice versa to cause the tip to withdraw into an interior portion of the protective cage.

14. The woodburning device according to claim 4, wherein the pushbutton comprises a command button.

15. The woodburning device according to claim 1, wherein blown or expelled air passes between the tip and an interior wall of the protective cage.

16. The woodburning device according to claim 1, wherein the fan aspirates exterior atmospheric air.

17. The woodburning device according to claim 1, wherein fumes are evacuated by an exhaust line located opposite the heated tip or moved further away by a flexible tube.

18. The woodburning device according to claim 1, further comprising a motor connected to the fan.
